(19) United States
(12) Patent Application Publication
(10) Pub. No.: US 2019/0384444 A1
(43) Pub. Date: Dec. 19, 2019

(54) SYSTEM AND METHOD FOR REDUCING ELECTROMAGNETIC INTERFERENCE

(71) Applicant: SYNAPTICS INCORPORATED, San Jose, CA (US)

(72) Inventor: Philip Andrew WINGARD, San Jose, CA (US)

(21) Appl. No.: 16/008,507

(22) Filed: Jun. 14, 2018

(51) Int. Cl. G06F 3/041; G06F 3/044

(52) U.S. Cl. CPC G06F 3/0416; G06F 2203/04107; G06F 3/044

(57) ABSTRACT

A system and method for reducing electromagnetic interference comprises generating a first voltage signal based on a settling time of a first electrode, a slew rate of a signal generator, and a harmonic parameter, and driving the first electrode with the first voltage signal. The first voltage signal may be one of a capacitive sensing signal, display update signal, a transmission signal, and a selection signal. Further, a processing system may be configured to operate in one of an absolute capacitive sensing mode and a transcapacitive sensing mode. In an absolute capacitive sensing mode, the processing system is configured to receive a resulting signal with the first electrode, and determine a measurement of a change in capacitive coupling of the first electrode based on the resulting signal. In a transcapacitive sensing mode, the processing system is configured to receive a resulting signal with a second electrode, and determining a measurement of a change in a capacitive coupling between the first electrode and the second electrode based on the resulting signal.

### TECHNICAL FIELD

Embodiments of disclosure generally relate to electronic devices and, more particularly, to reducing electromagnetic interference generated by electronic devices.

### BACKGROUND

Electromagnetic interference (EMI) may adversely affect electronic systems functioning within frequency bands similar to that of the EMI. For example, the EMI emissions may limit the ability for electronic systems to function as expected and cause erroneous data to be present within one or more devices of the electronic systems. In various implementations, EMI emissions are controlled by actively limiting the EMI emissions within the one or more frequency bands where the electronic systems are vulnerable, or configuring conflicting devices to function within different frequency bands.

Thus, there is a need to reduce EMI emissions generated by the devices that transmit signals within the operating frequency bands of electronic systems.

### SUMMARY

In one embodiment, a method for reducing electromagnetic interference comprises generating a first voltage signal based on a settling time of a first electrode, a slew rate of a signal generator, and a harmonic parameter, and driving the first electrode with the first voltage signal.

In another embodiment, a processing system comprises a signal generator configured to generate a first voltage signal based on a settling time of a first electrode, a slew rate of the signal generator, and a harmonic parameter, and a driver module configured to drive the first electrode with the first voltage signal.

In one embodiment, an electronic device comprises a plurality of electrodes, and a processing system coupled to the plurality of electrodes. Further, the processing system configured to generate a first voltage signal based on a settling time of a first electrode of the plurality of electrodes, a slew rate, and a harmonic parameter and drive the first electrode with the first voltage signal.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only some embodiments of this disclosure and are therefore not to be considered limiting of its scope, for the disclosure may admit to other equally effective embodiments.

FIG. 1 is a schematic block diagram of an exemplary electronic device, according to one or more embodiments.

FIG. 2 is a flow chart illustrating a method for generating a voltage signal according to one or more embodiments.

FIGS. 3 and 4 are schematic block diagrams of an exemplary electronic device, according to one or more embodiments.

FIGS. 5A-5B, 6A-6B, and 7A-7B illustrate example waveforms according to one or more embodiments.

FIG. 8 is a flow chart illustrating a method for generating a voltage signal according to one or more embodiments.

To facilitate understanding, identical reference numerals have been used, where possible, to designate identical elements that are common to the Figures. It is contemplated that elements disclosed in one embodiment may be beneficially utilized on other embodiments without specific recitation. The drawings should not be understood as being drawn to scale unless specifically noted. Also, the drawings may be simplified and details or components omitted for clarity of presentation and explanation. The drawings and discussion serve to explain principles discussed below, where like designations denote like elements.

### DETAILED DESCRIPTION

In one or more embodiments, a processing system of a capacitive sensing signal is configured to generate a voltage signal having reduced electromagnetic interference (EMI) within one or more frequency bands. The frequency bands may be of particular relevance to an electronic system, as the frequency bands may correspond to one or more operating frequencies of devices within the electronic system. However, altering parameters of the waveform of a voltage signal, reducing EMI emissions within the identified frequency bands or portions of the frequency bands.

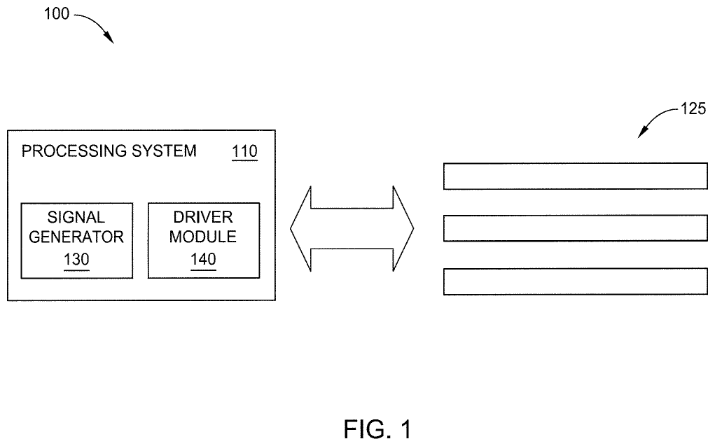

FIG. 1 is a block diagram of an exemplary electronic device 100, in accordance with embodiments of the disclosure. The electronic device 100 may be configured to provide input to an electronic system (not shown), and/or to update one or more devices. As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include electronic device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device. In other embodiments, the electronics system may part of an automobile, and the electronic device 100 represents one or more sensing devices of the automobile. In one embodiment, an automobile may include multiple electronic devices 100, where each electronic device 100 may be configured differently than the other.

The electronic device 100 can be implemented as a physical part of the electronic system, or can be physically separate from the electronic system. As appropriate, the electronic device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In one or more embodiments, the electronic device 100 may utilize any combination of sensor components and sensing technologies to detect user input. For example, as illustrated in FIG. 1, the electronic device 100 comprises one or more electrodes 125 that may be driven to detect objects or update one or more devices. In one embodiment, the electrodes 125 are sensor electrodes of a capacitive sensing device. In other embodiments, the electrodes 125 are electrodes of an image sensing device, radar sensing device, and ultrasonic sensing device. Further yet, the electrodes 125 may be display electrodes of a display device.

Some capacitive implementations utilize “self-capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage, or modulated with reference to the transmitter sensor electrodes to facilitate receipt of resulting signals. A resulting signal may comprise effect(s) corresponding to one or more transmitter signals, and/or to one or more sources of environmental interference (e.g. other electromagnetic signals). Sensor electrodes may be dedicated transmitters or receivers, or may be configured to both transmit and receive.

Capacitive sensing devices may be used for detecting input objects in proximity to and/or touching input devices. Further, capacitive sensing devices may be used to sense features of a fingerprint.

Some imaging implementations are configured to convert light waves into resulting signals. The waves maybe light waves or electromagnetic radiation. The imaging sensing devices may include a laser, scanner and optics, photodetectors, and receiver circuitry. In one embodiment, an imaging sensor is configured to convert light waves into current signals. In various embodiments, the imaging sensor may be one of a semiconductor charge-coupled device (CCD), complementary metal-oxide-semiconductor (CMOS) device, and N-type metal-oxide-semiconductor (NMOS) device. In such embodiments, the imaging sensors may be configured to detect visible light and/or infrared (IR) light, and convert the detected light into one or more images. Further, sensor elements may form the light detecting pixels of the imaging sensor, and each sensor element may represent a different pixel of the imaging sensor. Electrodes 125 may be driven with voltage signals to select one or more of the sensing elements for transmission, receiving, and/or readout. In one embodiment, a voltage signal is driven onto electrodes 125 coupled to the photodetectors to select the photodetectors for readout by processing system 110.

In other embodiments, the imaging sensor may include laser sensing devices. For example, the imaging sensor may be a LIDAR system that is configured to illuminate a target with pulsed laser light and measure the reflected pulses. In one embodiment, the distance to a target is determined based on the amount of time between the transmitted and received laser light. In one or more embodiments, a voltage signal is driven onto electrodes 125 to generate the laser signal via a photodiode. Further, a voltage signal may be driven onto electrodes 125 coupled to the photodetectors to select the photodetectors for readout by processing system 110.

Some ultrasonic sensing implementations detect objects by transmitting an ultrasonic pulse (e.g., ultrasonic signal) and measuring reflection of ultrasonic pulses. In one embodiment, the ultrasonic pulse is generated by a voltage signal. The voltage signal may be pulsed voltage signal. In an ultrasonic sensing implementation, the difference in time between the pulse being transmitted and the reflected signal (echo) may be measured to determine a distance between objects. In various embodiments, ultrasonic sensing may be referred to as Sonar. Electrodes 125 form the sensor electrodes of the ultrasonic sensor that are configured to transmit and/or receive the ultrasonic signals. In other embodiments, electrodes 125 are configured to select one of more of the sensor electrodes for readout by processing system 110.

The voltage signal may be a modulated signal (e.g., a varying voltage signal) used for capacitive sensing (e.g., a capacitive sensing signal). The modulated voltage signal may modulate between one or more voltages. Further, the voltage signal may be a data signal used for updating a display device. In other embodiments, the voltage signal is a transmission signal driven onto a photodiode or an ultrasonic transmitter. For example, the voltage signal may be a pulsed voltage signal comprising a plurality of voltage pulses between one or more voltages. Further yet, the voltage signal is a selection signal used to select one or more sensing elements for readout by a processing system.

In FIG. 1, a processing system 110 is shown as part of the electronic device 100. The processing system 110 is configured to operate hardware of the electronic device 100. As illustrated in FIG. 1, processing system 110 comprises a signal generator 130 and a driver module 140. In various embodiments, the processing system 110 comprises parts of or all of one or more integrated circuits (ICs) and/or other circuitry components.

In some embodiments, the processing system 110 also comprises electronically-readable instructions, such as firmware code, software code, and/or the like. In some embodiments, components composing the processing system 110 are located together, such as near sensing element(s) of the electronic device 100. In other embodiments, components of processing system 110 are physically separate with one or more components close to sensing element(s) of electronic device 100, and one or more components elsewhere. For example, the electronic device 100 may be a peripheral coupled to a desktop computer, and the processing system 110 may comprise software configured to run on a central processing unit of the desktop computer and one or more ICs (perhaps with associated firmware) separate from the central processing unit. As another example, the electronic device 100 may be physically integrated in a phone, and the processing system 110 may comprise circuits and firmware that are part of a main processor of the phone. Further yet, the processing system 110 may be implemented within an automobile, and the processing system 110 may comprise circuits and firmware that are part of one or more of the electronic control units (ECUs) of the automobile. In some embodiments, the processing system 110 is dedicated to implementing the electronic device 100. In other embodiments, the processing system 110 also performs other functions, such as operating display screens, driving haptic actuators, etc.

The processing system 110 may be implemented as a set of modules that handle different functions of the processing system 110 (e.g., signal generator 130 and driver module 140). Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In one embodiment, processing system 110 includes signal generator 130 and driver module 140. In other embodiments, processing system 110 may additionally include a determination module 360. Driver module 140 may include driver circuitry and/or display circuitry. For example, the driver module may include receiver circuitry configured to receive resulting signals from electrodes 125 (e.g., sensor electrodes, sensing pixels, photodetectors, ultrasonic receivers, and the like) and/or driver circuitry configured to drive electrodes 125 with the voltage signals.

In some embodiments, the processing system 110 responds to user input (or lack of user input) directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions. Further, in some embodiments, the processing system 110 is configured to identify one or more target objects, and the distance to the target objects.

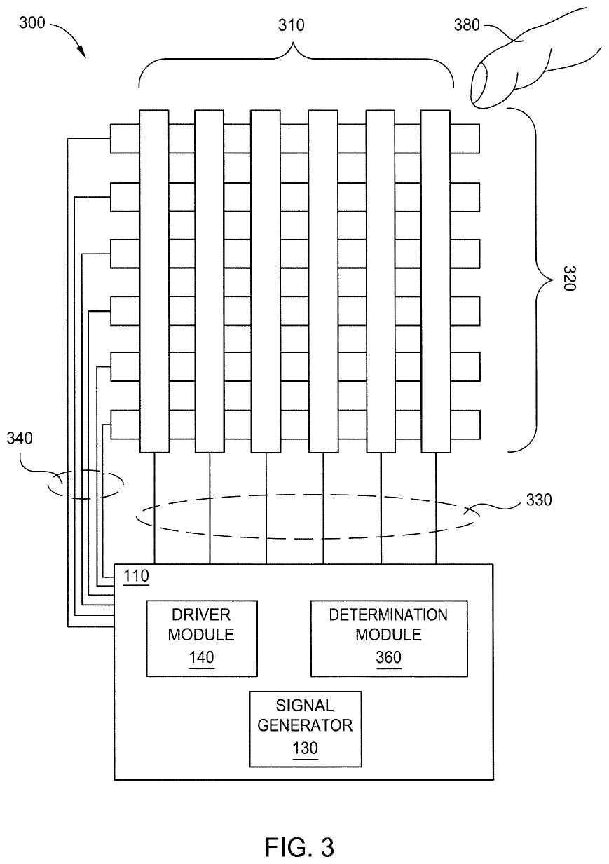

For example, in some embodiments, the processing system 110 operates electrodes 125 to produce electrical signals (resulting signals) indicative of input (or lack of input) in a sensing region. The processing system 110 may perform any appropriate amount of processing on the electrical signals in producing the information provided to the electronic system. For example, the processing system 110 may digitize analog electrical signals obtained from the electrodes 125. As another example, with reference to FIG. 3, the determination module 360 may perform filtering or other signal conditioning. As yet another example, determination module 360 of the processing system 110 may subtract or otherwise account for a baseline, such that the information reflects a difference between the electrical signals and the baseline. As yet further examples, determination module 360 of the processing system 110 may determine positional information, recognize inputs as commands, recognize handwriting, recognize fingerprint information, distance to a target object, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

“Fingerprint information” may include fingerprint features such as ridges and valleys and in some cases small features such as pores. Further, fingerprint information may include whether or not an input object is in contact with the input device.

It should be understood that while many embodiments of the disclosure are described in the context of a fully functioning apparatus, the mechanisms of the present disclosure are capable of being distributed as a program product (e.g., software) in a variety of forms. For example, the mechanisms of the present disclosure may be implemented and distributed as a software program on information bearing media that are readable by electronic processors (e.g., non-transitory computer-readable and/or recordable/writable information bearing media readable by the processing system 110). Additionally, the embodiments of the present disclosure apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

As illustrated in FIG. 1, processing system 110 comprises signal generator 130, and driver module 140. In one or more embodiments, the processing system 110 is configured to generate a voltage signal having minimized electrical (EMI) emissions in one or more frequency bands or portions of frequency bands, as compared to other voltage signals. In one embodiment, the processing system 110 is configured to determine one or more parameters of the electronic device 100 and generate the voltage signal based on the one or more parameters. In one embodiment, processing system 110 is configured to generate a voltage signal based on a settling time of an electrode 125, a slew rate of a signal generator, and a harmonic parameter. The slew rate may correspond to a slew rate of the signal generator 130. Further, processing system 10 may be configured to generate the voltage signal based on a settling time of a first electrode of electrodes 125 and a settling time of a second electrode of electrodes 125, a slew rate, and a harmonic parameter. The settling time of the first electrode is greater than or less than the settling time of the second electrode. In one embodiment, processing system 110 is configured to compare the settling times of each electrode of electrodes 125 and determine the electrode having the fastest settling time and the electrode having the slowest settling time. Further, the voltage signal may be determined based on the fastest settling time and the slowest settling time. In one or more embodiments, a voltage signal may be determined for each of electrodes 125 based on the corresponding settling time.

In one embodiment, the settling time of an electrode 125 corresponds to at least the combined RC time constant of an electrode 125 and any traces coupled to that electrode. Further, the RC time constant may correspond to a capacitive or ohmic coupling between an electrode 125 and other electrodes within the electronic device 100. In one embodiment, the electrode 125 may be one of sensor electrodes 310, 320. In other embodiments, the electrode may be a source electrode of a display device, a selection electrode and/or transmission electrode of an image sensor, and a transmitter and/or receiver of an ultrasonic sensing device. In yet other embodiments, electrode 125 may be any electrode of the electronic device 100 that is driven by processing system 110. In one embodiment, the settling time of an electrode is the amount of time it takes for the electrodes to be driven to a threshold voltage level.

The settling times of electrodes 125 may further depend on the waveform of the voltage signal driven onto the sensor electrodes. In one particular embodiment, an electrode may be considered to be settled when it reaches about at least 95% of the voltage of a voltage signal driven onto the electrode.

Signal parameters used to determine the voltage signal may include the shape of the waveform of the output signal, and a slew rate of the signal generator 130 (e.g., a maximum slope and/or minimum slope of a signal that the signal generator 130 is able to produce). Further, the one or more frequency bands (e.g., frequency ranges) correspond to frequencies where EMI emissions are to be minimized. In one embodiment, the frequency ranges may include piece-wise portions of one or more bands. The frequency ranges may correspond to operating frequencies of one or more devices of the electronic system associated with electronic device 100. In one embodiment, the frequency ranges correspond to harmonics of the capacitive sensing signal where electrical emissions are to be decreased. For example, the frequency ranges correspond to the third, fifth and seventh harmonics, where the first harmonic corresponds to the frequency of the capacitive sensing signal.

In one embodiment, the settling times of the electrodes 125 may be predetermined. For example, the settling times may be provided by a manufacturer of electronic device 100 and/or the electrodes 125. In other embodiments, the settling times may be calculated based on parameters of the electrodes and any intervening traces. For example, the width, length, and material composition of the electrodes 125 and traces coupled to the electrodes 125 may be used to determine the settling times. In other embodiments, the settling time may be determined by driving an electrode 125 with a test voltage signal and measuring how long it takes for the electrode or another electrode to reach a voltage threshold that indicates that the electrode is settled.

In one embodiment, the signal generator 130 comprises signal generator circuitry configured to provide the capacitive sensing signal. For example, the signal generator 130 may include an oscillator, one or more current conveyers and/or a digital signal generator circuit. In one embodiment, the signal generator circuitry generates the voltage signal based on a clock signal, the output of oscillator and the parameters discussed above. For example, the signal generator circuitry may be configured to output a trapezoidal waveform based on the output of the oscillator and the clock signal, where the rising edge of the voltage signal has a rise time and shape determined from the slope parameter, settling time parameter and harmonic parameter.

Signal generator 130 is configured to generate a voltage signal based on a slew rate, and a harmonic parameter, and a settling time parameter to reduce EMI of the voltage signal within corresponding to one or more frequencies. As is stated above, the voltage signal may be one of a capacitive sensing signal (e.g., a transmitter signal for transcapacitive sensing and/or an absolute capacitive sensing signal), display update signals (e.g., data signal) for display devices, selection and/or transmission signals for imaging sensors, and/or selection and/or transmission signals for ultrasonic sensors.

In one embodiment, generating the voltage signal comprises adjusting properties of rising edges and/or falling edges of the voltage signal based on the settling time of one or more of the electrodes 125, the slew rate, and one or more frequencies identified by the harmonic parameter. For example, in one embodiment, the signal generator 130 is configured to output a voltage signal having a trapezoidal shape, where the rising edges are adjusted based on settling time of one or more of the electrodes 125, the slew rate, and one or more frequencies identified by the harmonic parameter. In one embodiment, the rising edge is percentage of the period, and adjusting the rising edge includes varying the percentage of the period that is attributed to the rising edge.

The rise time and shape of the rising edge may be adjusted to reduce EMI of the voltage signal. For example, a slower rising edge may have minimal impact of settling of the sensor electrodes but may reduce EMI in the identified frequency band. The signal generator 130 may be configured to determine the rising edge time that reduces EMI in the identified frequency band, but also allows each sensor electrodes to settle such that driver module 140 is able to receive a resulting signal from the sensor electrodes.

The settling time parameter is based on a settling time of at least one electrode 125. In one embodiment, the settling time parameter is based on a fastest settling time and a slowest settling time of the electrodes 125. The slew rate corresponds to a maximum slope value and/or minimum slope value of a signal that signal generator 130 is able to generate. In one embodiment, slew rate corresponds to a maximum slope value and/or minimum slope value of a signal that may be generated by signal generator 130. In another embodiment, the slew rate corresponds to a maximum slope value and/or a minimum slope value of a signal waveform that is able to stay within predetermined operating conditions.

The harmonic parameter (or harmonic value) corresponds to one or more harmonics where EMI is to be reduced. For example, the harmonic parameter may correspond to a first harmonic and a last harmonic of the capacitive sensing signal where EMI emissions are to be reduced. The harmonic parameter also includes a first harmonic that corresponds to the frequency of the voltage signal.

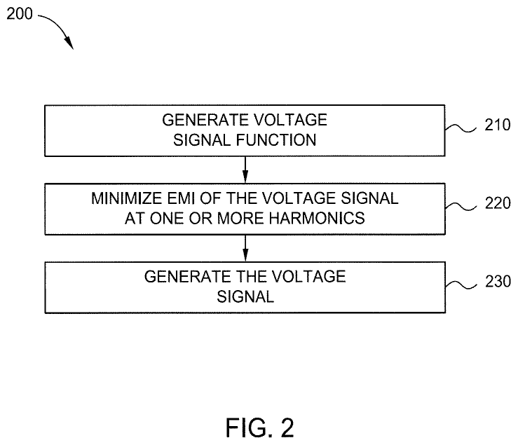

FIG. 2 illustrates an example method 200 for generating a voltage signal with minimized EMI in one or more frequency bands. The method 200 begins at step 210, where a voltage signal function is generated. For example, the voltage signal is generated based on a waveform function (f(n)) of the harmonic parameter, the slope parameter, and the length saturation parameter. Further, the voltage signal is generated based on one or more low pass filter functions (g(n)) that are based on the settling time parameter. In one embodiment, function g(n) may be generated based on the slowest and fastest settling times and used to generate a voltage signal used for each of the sensor electrodes. Alternatively, a different function, g(n), may be generated for each sensor electrode, and at least two of the functions may be used to generate a different voltage signal for each electrode 125 In one embodiment, the two functions may be convolved with each other to generate a function utilized to generate the voltage signal.

At step 220, the shape and/or rise time of the rising edge of the waveform of the capacitive sensing signal is adjusted based on the harmonics parameter. In one embodiment, the shape and/or rise time of the rising edge of the waveform may be adjusted by performing a Fourier transform at the harmonics specified by the harmonic parameter. In one embodiment, the maximum value of the magnitude is minimized to reduce EMI with respect to the identified frequencies. Further, in one or more embodiments, the rise time and shape of the rising edge is determined corresponding to the identified frequencies such that one or more of electrodes 125 is able to settle.

At step 230 of the method 200, the signal generator 130 generates the voltage signal. Equation 1 below may be utilized to generate a voltage signal having minimized EMI in the identified frequency band or bands. In one embodiment, equation 1 is convex and may be solved using a convex optimization solver to determine the capacitive sensing signal. In one or more embodiments, equation 1 is minimized while satisfying restrictions that are present with the input device. For example, a restriction may be a slew rate of the signal generator 130 and/or a requirement to have a sensor electrode settle at about 95% of the voltage of the voltage signal.

$$\frac{Maximum}{∀ k ∈ [ a , b ]} [ ‖ {\sum }_{n = 1}^{end} conv [ f ( n ) , g ( n ) ] * exp ( - i * 2 * π * ( k - 1 ) * \frac{n - 1}{N} ) ‖ ] . \qquad 1$$

Equation 1 may be utilized to generate a voltage signal having with minimal emissions in the specified frequencies. The frequencies are represented by [a,b] in equation 1, and may correspond to a continuous band of frequencies or a piecewise selection of frequencies. Equation 1 takes as an input a vector representing waveform, convolves this vector to predict the output waveform. Further, a Fourier transform is performed at the selected frequencies and the magnitude of those values are utilized to calculate a maximum value. In one embodiment, after the maximum value is determined, the function of equation 1 is minimized to provide a minimum value.

In one embodiment, method 200 may be utilized to minimize the maximum emission ion a specific range of frequencies by altering the rising edge of the waveform and maintaining several strict requirements of the output waveform. For example, method 200 reduces the worst case EMI emission in a specific range by at least 20dB in comparison to an unaltered waveform while conforming to the conditions of the signal generator 130. For example, the unaltered waveform may be a trapezoid waver.

With reference to FIG. 3, input device 300 illustrates an embodiment of electronic device 100 comprising a touch screen interface, and a sensing region of the input device 300. In one embodiment, the sensing region overlaps at least part of an active area of a display screen. For example, the input device 300 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 300 and the display screen may share physical elements. For example, some embodiments may utilize some of the same electrical components for displaying and sensing. As another example, the display screen may be operated in part or in total by the processing system 110.

FIG. 3 illustrates a portion of an exemplary pattern of sensor electrodes 310, 320 configured to sense in a sensing region of input device 300, according to some embodiments. In one embodiment, input device 300 may be referred to as a capacitive sensing device. FIG. 3 further illustrates processing system 110 and routing traces 330, 340. In the embodiment of FIG. 3, processing system 110 includes a driver module 140, a determination module 360, and a signal generator 130. Further, the processing system 110 is coupled to sensor electrodes 310 via routing traces 330 and sensor electrodes 320 via routing traces 340. In various embodiments, processing system 110 may additionally, or alternatively, include one or more modules not illustrated in FIG. 3. For example, processing system 110 may include a display driver module configured to update a display of a display device. In one embodiment, driver module 140 is configured to perform both capacitive sensing and display updating.

For clarity of illustration and description, the sensor electrodes 310 and 320 are illustrated as being simple rectangles, however, in other embodiments, the sensor electrodes may have other shapes and/or sizes. The sensor electrodes 310, 320 may be formed from electrodes 125. In one embodiment, the sensor electrodes 310, 320 form areas of localized capacitance (capacitive coupling). The areas of localized capacitance may be used to determine one or more capacitive pixels of a capacitive image. Further, the areas of localized capacitance may be formed between each of the sensor electrodes 310, 320 and ground in a first mode of operation and between groups of sensor electrodes 310, 320 used as transmitter and receiver electrodes in a second mode of operation.

The capacitive couplings between sensor electrodes 310 and sensor electrodes 320 or between sensor electrodes 310, 320 and an input object changes with the proximity and motion of input objects in the sensing region associated with the sensor electrodes. The change in capacitive couplings may be used as an indicator of the presence of the input object in the sensing region of the input device.

The sensor electrodes 310, 320 may be disposed within separate planes or in a common plane. For example, the sensor electrodes 310 may be disposed on a first side of a substrate and the sensor electrodes 320 are disposed on a second side of the substrate. In another example, the sensor electrodes 310, 320 are disposed on separate substrates. Further, the sensor electrodes 310, 320 may be disposed on a common side of a substrate.

It is contemplated that the pattern of sensor electrodes 310, 320 may have other configurations, such as polar arrays, repeating patterns, non-repeating patterns, non-uniform arrays a single row or column, or other suitable arrangement. Further, as will be discussed in more detail below, the sensor electrodes 310 may be any shape such as circular, rectangular, diamond, star, square, noncovex, convex, nonconcave concave, etc. Further, as is illustrated in FIG. 3, the sensor electrodes 310 are coupled to the processing system 110 and utilized to determine the presence (or lack thereof) of an input object in the sensing region.

The driver circuitry of driver module 140 may include driver circuitry such as one or more amplifiers, digital to analog to digital converters, analog to digital converters, and/or analog front ends (AFEs). Each AFE may include an amplifier with a feedback capacitor coupled between the output the amplifier and an inverting input of the amplifier. A reset switch or a resistor may be coupled in parallel with the feedback capacitor. Further, the AFE may include one or more sample and hold circuits, analog to digital converters and/or filters coupled to the output of the amplifier.

In one embodiment, in a transcapacitive sensing mode, the driver circuitry drives a sensor electrode of sensor electrodes 320 with a capacitive sensing signal through an output of an amplifier and receives a resulting signal with a sensor electrode of sensor electrodes 310 via an AFE coupled to the sensor electrode. In another embodiment, in an absolute capacitive sensing mode, a non-inverting input of the AFE is driven with a capacitive sensing signal to module a sensor electrode coupled to the AFE (e.g., one of sensor electrodes 310, 320), and a resulting signal is received from the sensor electrode via the inverting input of the AFE.

With continued reference to FIG. 3, the settling time may correspond to RC time constant of the sensor electrodes 310, 320 and any corresponding traces (traces 330 and/or 340). The RC time constant may further correspond to any ohmic connections between the sensor electrodes 310, 320 and traces 330, 340 and between the traces and processing system 110. Further, the RC time constant may further correspond to the capacitive coupling between a sensor electrode and other electrodes within the input device 300. In a transcapacitive sensing mode, the settling time may correspond to the RC time constant of one of sensor electrodes 320, one of sensor electrodes 310, and the corresponding traces. In an absolute capacitive sensing mode, the settling time may correspond to the RC time constant of one of sensor electrodes 310 and a corresponding trace, or the RC time constant of one of sensor electrodes 320 and a corresponding trace.

In one embodiment, the determination module 360 may be configured to determine a settling time for each of sensor electrodes 310 and/or 320. Further, the determination module 360 may be configured to determine fastest settling time of the sensor electrodes and the slowest settling time of the sensor electrodes based on the provided settling times, the calculated settling times and/or the determined settling times. However, in another embodiment, the fastest settling time and the slowest settling time are predetermined.

The signal generator 130 is configured to generate a capacitive sensing signal based on a slope parameter, and a harmonic parameter, and a settling time parameter, to reduce EMI of the capacitive sensing signal within one or more frequency bands, using method 200.

In one embodiment, signal generator 130 is configured to generate a transmitter signal for each sensor electrode 320. In such an embodiment, a different transmitter signal is driven onto each sensor electrode 320 to perform transcapacitive sensing. In another embodiment, signal generator 130 is configured to generate a transmitter signal for sensor electrodes 320. In such an embodiment, a common (e.g., global) transmitter signal is driven onto each sensor electrode 320 to perform transcapacitive sensing.

In one or more embodiments, signal generator 130 is configured to generate an absolute capacitive sensing signal for each sensor electrode 310, 320. In such an embodiment, an absolute capacitive sensing signal is driven onto each sensor electrode 310, 320 to perform absolute capacitive sensing. In another embodiment, signal generator 130 is configured to generate an absolute capacitive sensing signal for sensor electrodes 310 and an absolute capacitive sensing signal for sensor electrodes 320. In such an embodiment, a first absolute capacitive sensing signal is driven onto sensor electrodes 310 and a second absolute capacitive sensing signal is driven on sensor electrodes 320 to perform absolute capacitive sensing. In yet another embodiment, signal generator 130 is configured to generate an absolute capacitive sensing signal for sensor electrodes 310, 320. In such an embodiment, a common (e.g., global) absolute capacitive sensing signal is driven onto each sensor electrode 310, 320.

In one embodiment, the signal generator 130 may be configured to generate a capacitive sensing signal or signals that may be communicated to the driver module 140 or stored in a memory and accessed by driver module 140. The driver module 140 drives one or more sensor electrodes 310, 320 with the capacitive sensing signal to acquire one or more resulting signals. For example, in a transcapacitive sensing mode, the driver module 140 drives one of sensor electrodes 320 with a transmitter signal and receives a resulting signal with one of sensor electrodes 310, the resulting signal comprising effects corresponding to the transmitter signal. In one embodiment, each of sensor electrodes 320 is driven by driver module 140 in a sequential manner with the transmitter signal. Further, each of sensor electrodes 310 may simultaneously receive resulting signals while the sensor electrodes 320 are driven. Further, driver module 140 may be configured to drive more than one of sensor electrodes 320 simultaneously with transmitter signals, where the transmitter signals are modulated based codes.

In an absolute capacitive sensing mode, the driver module 140 drives one of sensor electrodes 310, 320 with an absolute capacitive sensing signal and receives a resulting signal with the driven sensor electrode. In one embodiment, each of sensor electrodes 310 is simultaneously driven by driver module 140 with the absolute capacitive sensing signal, and resulting signals are received with sensor electrodes 310 by driver module 140. Further, each of sensor electrodes 320 is simultaneously driven by driver module 140 with the absolute capacitive sensing signal, and resulting signals are received with sensor electrodes 320 by driver module 140. In one embodiment, sensor electrodes 310, 320 are simultaneously driven by driver module 140 with the absolute capacitive sensing signal, and resulting signals are received from sensor electrodes 310, 320 by driver module 140.

In an embodiment, the signal generator 130 may utilize additional parameters to determine the capacitive sensing signal. For example, the signal generator may additionally utilize a length saturation parameter corresponding to a length of time that the waveform of the capacitive sensing signal is flat, representing a non-rising/non-falling edge of the waveform.

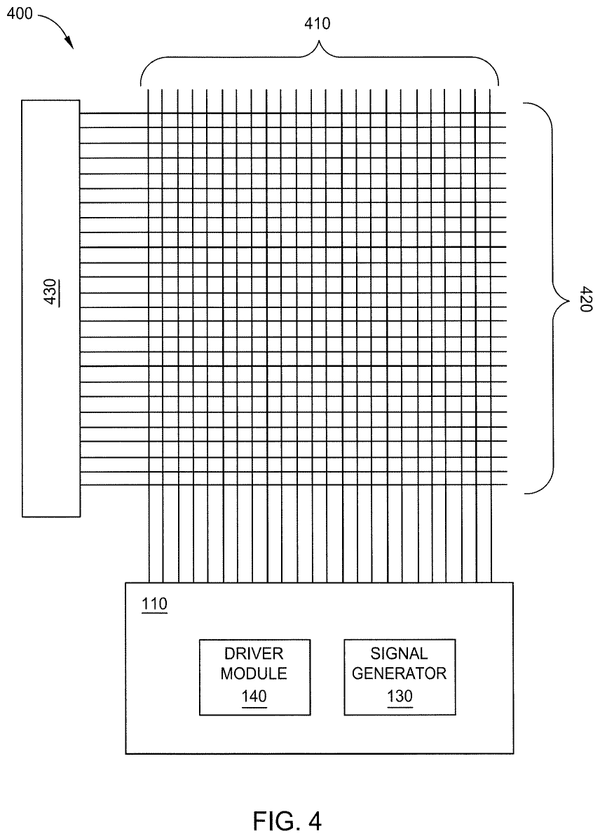

FIG. 4 illustrates a display device 400 comprising gate electrodes 420 and source electrodes 410. Each of the gate electrodes 420 is coupled to gate selection circuitry 430 and each of the source electrodes 410 are coupled to processing system 110. In one embodiment, driver module 140 comprises source drivers and each of the source electrodes 410 are coupled to a different one of the source drivers. In one embodiment, the gate selection circuitry is configured to drive gate electrodes 420 with a selection signal to select corresponding subpixels for display updating. Further, driver module 140 is configured to drive each of the source electrodes 410 with a data signal to update selected subpixels of the display device. The data signal may be a voltage signal that ramps to a specific voltage level to update a subpixel of a display. Display device 400 is one of an organic light emitting diode (OLED) display and a liquid crystal display (LCD) device.

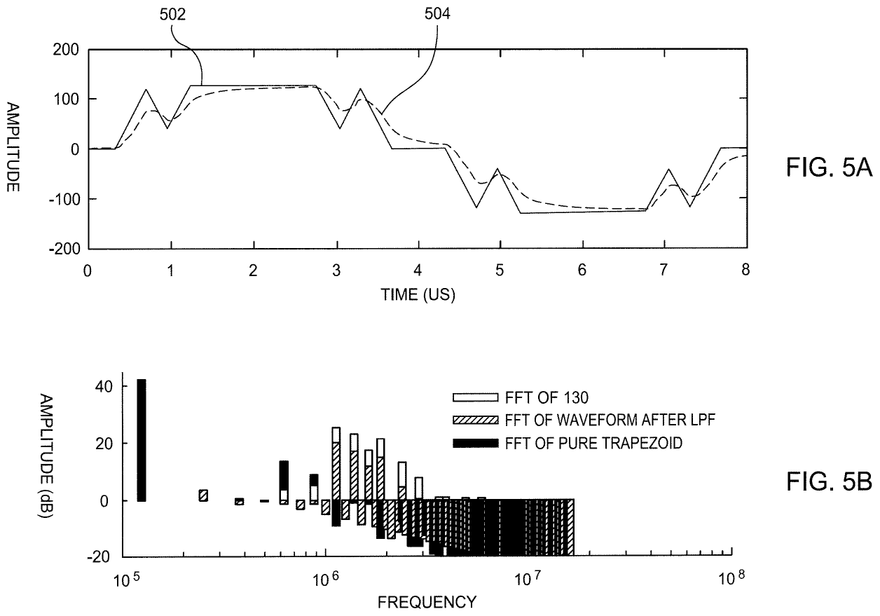

FIG. 5A illustrates a capacitive sensing signal 502 not having minimized EMI and a capacitive sensing signal 504 having minimized EMI. In the illustrated embodiment, capacitive sensing signal 504 has a rising edge of 17% of the period and EMI has been minimized in the 3^{rd}, 5^{th} and 7^{th} harmonics. An EMI minimized capacitive sensing signal may reduce EMI within the frequency range by about 20 percent as compared to non-EMI minimized capacitive sensing signal. In other embodiments, EMI may be reduced by percentages greater than 20 percent. FIG. 5B illustrates the amplitude reduction of the capacitive sensing signal before and after EMI has been minimized in the 3^{rd}, 5^{th} and 7^{th} harmonics.

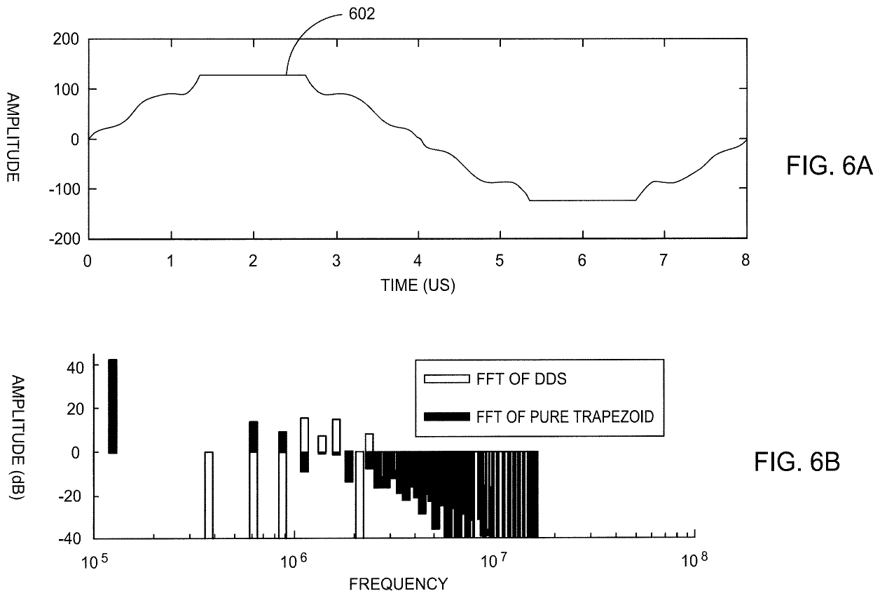

FIG. 6A illustrates a capacitive sensing signal 602 determined using equation 1, but with the convolution of f(n) and g(n) removed. As compared to waveform of capacitive sensing signal 502, the waveform of capacitive sensing signal 602 has a different shape and is closer to a true trapezoidal waveform. Further, the amplitude of signal response of capacitive sensing signal 602 in the selected frequency range is lower than that of capacitive sensing signal 502. FIG. 6B illustrates the amplitude reduction of the capacitive sensing signal in the 3^{rd}, 5^{th} and 7^{th} harmonics.

In various embodiments, while capacitive sensing signals 502 and 602 are illustrated as having trapezoidal waveforms, in other embodiments, other waveform shapes may be used. For example, square, triangular and sinusoidal waveforms may be utilized.

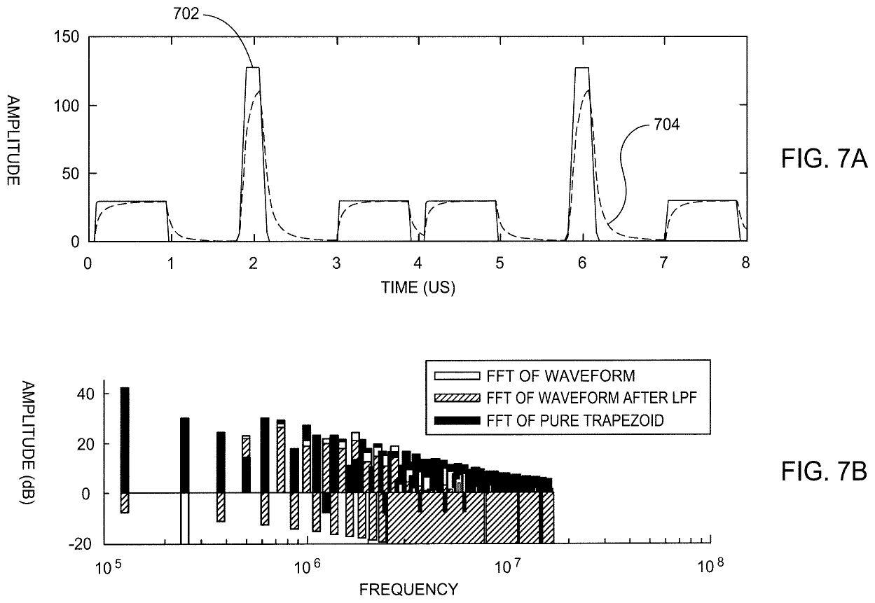

FIG. 7A illustrates a pulsed voltage signal 702 not having minimized EMI and a pulsed voltage signal 704 having minimized EMI. The pulsed voltage signal may be used to drive a transmitter of an ultrasonic device. In the illustrated embodiment, EMI of the pulsed voltage signal 704 has been minimized in the 3^{rd}, 5^{th} and 7^{th} harmonics. FIG. 7B illustrates the amplitude reduction of the capacitive sensing signal before and after EMI has been minimized in the 3^{rd}, 5^{th} and 7^{th} harmonics. The pulsed voltage signal 704 may be used within distance detection devices, for example, ultrasonic sensing devices and laser sensing devices.

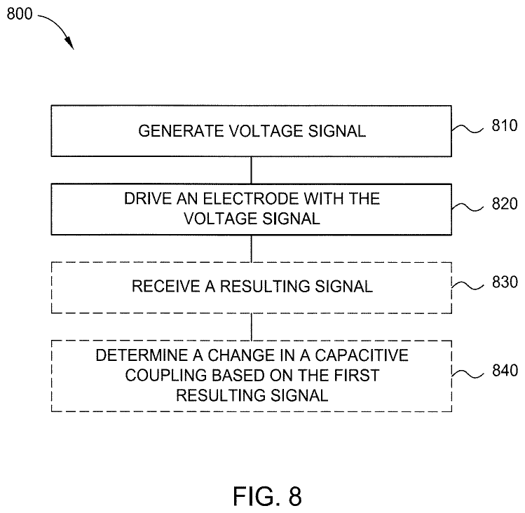

FIG. 8 illustrates a method 800 for reducing electromagnetic interference according to one or more embodiments. At step 810, a voltage signal is generated. The voltage signal may be one of a capacitive sensing signal, a display update signal, a selection signal, and a transmission signal. In one embodiment, the signal generator 130 may be configured to generate the voltage signal based on a settling time of the sensor electrode, a harmonic parameter and a slope parameter. In one embodiment, the signal generator 130 receives the settling time or times from the memory of processing system 110, generates the voltage signal that is utilized for capacitive sensing for each of the sensor electrodes, and communicates the voltage signal to driver module 140. In another embodiment, the signal generator 130 generates more than voltage signal. For example, the signal generator 130 may be configured to generate a voltage signal that is unique for each electrode 125.

In one embodiment, the signal generator 130 solves a function corresponding to the settling time or times and a waveform shape to generate a capacitive sensing signal having minimized EMI in a selected frequency range. The function may take into account the settling time of the electrode(s), a slew rate and harmonic parameter to adjust the rising time and shape of the rising edge of the capacitive sensing signal used for one or more of transcapacitive sensing and absolute capacitive sensing. In one embodiment, the rising time and shape of the rising edge determined by signal generator 130 may be stored within a memory of processing system 110.

At step 820 one or electrodes 125 is driven with the voltage signal. The voltage signal may be used as a transmitter signal for transcapacitive sensing or an absolute capacitive signal for absolute capacitive sensing. For example, the driver module 140 maybe configured to drive one or more sensor electrodes 320 with the capacitive sensing signal or signals while receiving resulting signals from sensor electrodes 310 to perform transcapacitive sensing. In an absolute capacitive sensing mode, the driver module 140 may be configured to drive sensor electrodes 310 and/or 320 with the capacitive sensing signal or signals, while receiving resulting signals from the driven electrodes to perform absolute capacitive sensing.

In another embodiment, the voltage signal may be used as a data signal for a display device, a selection signal for an imaging sensor, and a transmission signal for an ultrasound or imaging device.

In other embodiments, the generated voltage signal is a data signal for display updating, and driving the electrode with the voltage signal updates a display of a display device. In one embodiment, voltage signal maybe the common voltage signal driven onto the common voltage electrode of the display device.

Step 830 of method 800 is an optional step of receiving a resulting signal. For example, step 830 may be implemented by embodiments configured for transcapacitive sensing or absolute capacitive sensing. For example, a resulting signal may be received by a first sensor electrode of sensor electrodes 310, 320 by driving the sensor electrode with the capacitive sensing signal, where the resulting signal comprises effects corresponding to the capacitive sensing signal. In another embodiment, a resulting signal may be received by a sensor electrode of sensor electrodes 310 by driving a sensor electrode of sensor electrodes 320 with the capacitive sensing signal, where the resulting signal comprises effects corresponding to the capacitive sensing signal.

In another embodiment, optional step 830 of method 800 may include receiving a resulting signal from a first sensor element of an imaging device by driving a column electrode with a column selection signal. The column selection signal may select a sensing element for readout when a corresponding row of sensor elements are selected. The column selection signal may also be referred to as a readout signal. Further, driving an electrode 125 with the voltage signal may comprise driving a photodiode to generate a laser signal, which may be received by a photodiode as the resulting signal. In other embodiment, receiving a resulting signal is done by transmitting a first ultrasonic signal, wherein the ultrasonic signal is generated by driving one or more electrodes with a pulsed voltage signal. Further, a resulting signal may be received from an imaging element via a selection electrode by driving the selection electrode with a selection voltage.

In optional step 840 of method 800, the determination module 360 is configured to determine measurements of changes in capacitive coupling between sensor electrodes or between sensor electrode and an input object based on the resulting signals received while performing capacitive sensing. For example, in a transcapacitive sensing mode, the determination module 360 is configured to determine changes capacitive couplings between sensor electrodes, transmitter electrodes and receiver electrodes. For example, the determination module 360 acquires the resulting signals from the driver module 140 or a memory element, removes a baseline from the resulting signals, and demodulates the resulting signals to determine measurements of the changes in capacitive coupling between sensor electrodes 310, 320.

In an absolute capacitive sensing mode, the determination module 360 is configured to determine changes of a capacitive coupling between a driven sensor electrode and an input object based on resulting signal received with the driven sensor electrode. The determination module 360 may be configured to acquire the resulting signals from the driver module 140 or a memory element, remove a baseline from the resulting signals and demodulate the resulting signals to determine measurements of the changes in capacitive coupling for between each of the sensor electrodes 310 and/or 320 and an input object 380.

The determination module 360 may be configured to determine positional information for an input object (e.g., input object 380) based on the measurements of changes in capacitive coupling between sensor electrodes and/or between a sensor electrode and the input object. In one embodiment, the determination module 360 generates one or more profiles or a capacitive image based on the measurements of changes in capacitive coupling. The determination module 360 determines maximum and minimum values of the one or more profiles or a capacitive image, compares the maximum and minimum values to threshold values to determine positional information for an input object (input object 380) in the sensing region of input device 300.

In one or more embodiments, the determination module 360 communicates at least one of the measurements of changes in capacitive coupling, the one or profiles and the capacitive image to another element within processing system 110 or another processor within input device 300, which is configured to determine positional information for an input object.

In another embodiment, determination module 360 may be configured to determine distance to one or more target objects and/or the location of objects based on the resulting signals. For example, the determination module 360 may determine a time difference from when a signal was transmitted to when the corresponding resulting signal was received. The time difference may be used to determine a distance to a target object. Further, determination module 360 may be configured to determine if the distance has increased or decreased.

Thus, the embodiments and examples set forth herein were presented in order to best explain the embodiments in accordance with the present technology and its particular application and to thereby enable those skilled in the art to make and use the disclosure. However, those skilled in the art will recognize that the foregoing description and examples have been presented for the purposes of illustration and example only. The description as set forth is not intended to be exhaustive or to limit the disclosure to the precise form disclosed.

In view of the foregoing, the scope of the present disclosure is determined by the claims that follow.

What is claimed is:

1. A method for reducing electromagnetic interference, the method comprising:
generating a first voltage signal based on a first settling time of a first electrode, a slew rate of a signal generator, and a harmonic parameter; and
driving the first electrode with the first voltage signal.

2. The method of claim 1, wherein the first voltage signal is one of a capacitive sensing signal, display update signal, a transmission signal, and a selection signal.

3. The method of claim 2, wherein the first voltage signal is the capacitive sensing signal, and wherein the method further comprises:
receiving a resulting signal with the first electrode, the resulting signal comprises effects corresponding to the first voltage signal; and
determining a measurement of a change in capacitive coupling of the first electrode based on the resulting signal.

4. The method of claim 2, wherein the first voltage signal is the capacitive sensing signal, and wherein the method further comprises:
receiving a resulting signal with a second electrode, the resulting signal comprises effects corresponding to the first voltage signal; and
determining a measurement of a change in a capacitive coupling between the first electrode and the second electrode based on the resulting signal.

5. The method of claim 1, further comprising:
generating a second voltage signal based on a second settling time of a second electrode, the slew rate of the signal generator, and the harmonic parameter; and
driving the second electrode with the second voltage signal.

6. The method of claim 1, wherein the first voltage signal is further generated based on a second settling time of a second electrode, wherein the first settling time is faster than the second settling time.

7. The method of claim 1, wherein generating the first voltage signal comprises:
determining at least one of a rise time and a shape of a rising edge of the first voltage signal based on the first settling time of the first electrode, the slew rate of the signal generator, and the harmonic parameter.

8. The method of claim 1, wherein the slew rate corresponds to a maximum slope value and a minimum slope value of the signal generator.

9. The method of claim 1, wherein the harmonic parameter comprises a first harmonic value and a second harmonic value corresponding boundaries of a frequency band.

10. The method of claim 1, wherein the first settling time of the first electrode corresponds to an RC time constant of the first electrode and a trace coupled to the first electrode.

11. A processing system comprising:
a signal generator configured to generate a first voltage signal based on a settling time of a first electrode, a slew rate of the signal generator, and a harmonic parameter; and
a driver module configured to drive the first electrode with the first voltage signal.

12. The processing system of claim 11, wherein the driver module is further configured to: receive a resulting signal with the first electrode by driving the first electrode with the first voltage signal, wherein the processing system further comprises:
a determination module configured to determine a measurement of a change in capacitive coupling based on the resulting signal, and wherein the first voltage signal is a capacitive sensing signal.

13. The processing system of claim 11, wherein the driver module is further configured to: receive a resulting signal with a second electrode by driving the first electrode with the first voltage signal, the resulting signal comprising effects corresponding to the first voltage signal, wherein the processing system further comprises:
a determination module configured to determine a measurement of a change in capacitive coupling between the first electrode and the second electrode based on the resulting signal, and wherein the first voltage signal is a capacitive sensing signal.

14. The processing system of claim 11 wherein the signal generator is further configured to: generate the first voltage signal based on a settling time of a second electrode, wherein the settling time of the first electrode is faster than the settling time of the second electrode.

15. The processing system of claim 11, wherein generating the first voltage signal comprises:
determining at least one of a rise time and a shape of a rising edge of the first voltage signal based on the settling time of the first electrode, the slew rate, and the harmonic parameter.

16. The processing system of claim 11, wherein the slew rate corresponds to a maximum slope value and a minimum slope value of the signal generator, the harmonic parameter comprises a first harmonic value and a second harmonic value corresponding boundaries of a frequency band, and the settling time of the first electrode corresponds to an RC time constant of the first electrode and a trace coupled to the first electrode.

17. An electronic device comprising:
a plurality of electrodes;
a processing system coupled to the plurality of electrodes, the processing system configured to:
generate a first voltage signal based on a settling time of a first electrode of the plurality of electrodes, a slew rate, and a harmonic parameter; and
drive the first electrode with the first voltage signal.

18. The electronic device of claim 17, wherein the processing system is further configured to:
receive a resulting signal with the first electrode by driving the first electrode with the first voltage signal, the resulting signal comprises effects corresponding to the first voltage signal; and
determine a change in capacitive coupling of the first electrode based on the resulting signal.

19. The electronic device of claim 17, wherein the processing system is further configured to:
receive a resulting signal with a second sensor electrode by driving the first electrode with the first voltage signal, the resulting signal comprises effects corresponding to the first voltage signal; and
determine a change in capacitive coupling between the first electrode and the second sensor electrode based on the resulting signal.

20. The electronic device of claim 17, wherein the processing system is further configured to: generate the first voltage signal based on a settling time of a second electrode, wherein the settling time of the first electrode is faster than the settling time of the second electrode.
